(19) United States
(12) Patent Application Publication
(10) Pub. No.: US 2023/0127646 A1
(43) Pub. Date: Apr. 27, 2023

(54) MOLDING COMPOSITIONS REINFORCED WITH GLASS FIBERS HAVING IMPROVED IMPACT PROPERTIES

(71) Applicant: ARKEMA FRANCE, Colombes (FR)

(72) Inventors: Mathieu SABARD, Serquigny (FR); Benoît BRULE, Serquigny (FR)

(73) Assignee: ARKEMA FRANCE, Colombes (FR)

(21) Appl. No.: 17/905,959

(22) PCT Filed: Mar. 23, 2021
(86) PCT No.: PCT/FR2021/050483

§ 371 Date: Sep. 9, 2022

(30) Foreign Application Priority Data
Mar. 24, 2020 (FR) 2002859

(51) Int. Cl. C08L 77/10; C08K 7/14; C08L 23/00; B29C 45/00

(52) U.S. Cl. CPC C08L 77/10; C08K 7/14; C08L 23/00; B29C 45/0001; B29C 45/0005; C08L 2203/20; B29K 2877/00; B29K 2105/12

(57) ABSTRACT

A composition including: (A) from 29 to 74% by weight of at least one semi-crystalline aliphatic polyamide, the semi-crystalline aliphatic polyamide obtained from the polycondensation: of at least one C₆ to C₁₈ amino acid; or at least one C₆ to C₁₈ lactam; or at least one C₄ to C₃₆ diamine Ca with at least one C₄ to C₃ diacid Cb; (B) from 25 to 70% by weight of glass fibers mainly of silica dioxide (SiO2), aluminum oxide (Al2O3) and magnesium oxide (MgO); the glass fibers (B) having from 62 to 66% by weight of SiO2; (C) from 1 to 20% by weight of at least one impact modifier; and (D) from 0 to 2% by weight of at least one additive, excluding copper chromite, zinc sulfide, titanium dioxide, calcium carbonate and a polyolefin-based colored masterbatch; the sum of the various constituents (A) to (D) being 100% by weight.

### TECHNICAL FIELD

The present invention relates to polyamide compositions, used especially for injection molding, for applications in the field of quick couplers such as for trucks, cars, etc., but also in the field of electrics and electronics, sport and industry, to the method for preparing same and to the articles obtained from this composition.

### PRIOR ART

Tubes are necessary for transporting various types of fluids. For example, in motor vehicles, tubes are used to supply fuel from the tank to the engine, for the cooling circuit, for the hydraulics system, for the air conditioning system, etc.

Polyamides are widely used for the production of these tubes. In light of all the technical requirements involved, it is often necessary to use multilayer structures. For example, use is often made of at least one external layer based on a polyamide having a relatively high average number of carbon atoms per nitrogen atom (such as PA11 or PA12), providing the flexibility, mechanical strength and chemical resistance desired for the tubes; and at least one internal layer, referred to as barrier layer, providing the necessary impermeability to the transported fluids. Polyamides having a relatively low number of carbon atoms per nitrogen atom (for example PA6 or PA6.6), and also non-polyamide materials, such as an ethylene-vinyl alcohol copolymer, may be included in the barrier layer.

The above tubes are either connected to one another or connected to functional parts (such as filters) using connectors or couplers, and especially quick couplers.

Conventional couplers are customarily produced by injection molding, using a polyamide material such as PA6, PA11, PA12 or polyphthalamides (PPA), generally reinforced with glass fibers, especially type E.

However, quick couplers require a rigid material which therefore has a high tensile modulus as determined according to standard ISO 527, and which have a good impact strength, in particular high impact strength properties at −40° C. as determined according to standard ISO 179/1eA and particular greater than those of products such as PA11 with 30% type E glass fibers, or PA11 or PA12 with 50% type E glass fibers.

International application WO 2019/095099 describes compositions comprising from 81 to 98% by weight of linear aliphatic polyamide having an average number of carbon atoms in the monomeric units of C₁₀-C₁₄, from 1 to 9% by weight of type S glass fibers and from 1 to 10% by weight of impact modifier.

The compositions obtained have an elongation at break according to ISO 527 which is much lower for the comparative compositions comprising type E glass fibers compared to type S glass fibers. Nonetheless, regardless of the fibers used, the tensile modulus is too low for quick coupler applications. Moreover, this document does not mention the impact strength at low temperature (−40° C.).

Application US2014/0066561 describes compositions based on polyamide, glass fibers consisting predominantly of silicon dioxide, aluminum dioxide and magnesium oxide and particulate fillers. According to this application, particulate fillers are used in many cases with glass fibers, whether to color the molding compositions using inorganic pigments or to carry out other specific modifications of the characteristics, but they have the disadvantage of commonly adversely affecting the mechanical characteristics, in particular by reducing the tensile strength, elongation at break and impact strength.

Moreover, still according to this application, said E glass fibers having a circular section are used virtually exclusively during the reinforcement of polyamide molding compositions with glass fibers.

In accordance with standard ASTM D578-00, the E glass fibers are composed of 52 to 62% silicon dioxide, 12 to 16% aluminum oxide, 16 to 25% calcium oxide, 0 to 10% borax, 0 to 5% magnesium oxide, 0 to 2% alkali metal oxides, 0-1.5% titanium dioxide and 0-0.3% ferric oxide.

According to US2014/0066561, without particulate fillers, the mechanical properties and especially the impact strength of the compositions with type E glass fibers or type S glass fibers are substantially equivalent but nevertheless insufficient for a quick coupler application. The addition of particulate fillers, and especially of copper chromite, into these compositions significantly deteriorates the mechanical properties but the degradation is slower with the S fibers.

Application US 2019/0153221 describes molding compositions having improved impact properties and comprising a semi-crystalline aliphatic polyamide, an impact modifier and glass fibers.

The present invention therefore relates to a composition, particularly useful for injection molding, comprising:

(A) from 29 to 89%, in particular 29 to 74%, and more particularly 34 to 64%, especially from 44 to 54% by weight of at least one semi-crystalline aliphatic polyamide, said semi-crystalline aliphatic polyamide resulting from the polycondensation:
of at least one C₆ to C₁₈, preferentially C₉ to C₁₈, more preferentially C₁₀ to C₁₈, even more preferentially C₁₀ to C₁₂, especially C₁₁, amino acid, or
of at least one C₆ to C₁₈, preferentially C₉ to C₁₈, more preferentially C₁₀ to C₁₈, even more preferentially C₁₀ to C₁₂, especially C₁₂, lactam, or
of at least one C₄-C₃₆, especially C₆-C₃₆, preferentially C₆-C₁₈, preferentially C₆-C₁₂, more preferentially C₁₀-C₁₂, diamine Ca with at least one C₄-C₃₆, especially C₆-C₃₆, preferentially C₆-C₁₈, preferentially C₁₀-C₁₈, more preferentially C₁₀-C₁₂, diacid Cb,
(B) from 10 to 70, in particular 25 to 70%, and more particularly 35 to 65%, especially 45 to 55% by weight of glass fibers predominantly consisting of silica dioxide (SiO2), aluminum oxide (Al2O3) and magnesium oxide (MgO);
(C) from 1 to 20% by weight of at least one impact modifier; and
(D) from 0 to 2%, preferably 1 to 2% by weight of at least one additive, excluding copper chromite, zinc sulfide, titanium dioxide, calcium carbonate and a polyolefin-based colored masterbatch;
the sum of the various constituents (A) to (D) being 100% by weight.

The inventors thus found, unexpectedly, that the use of an impact modifier in a composition comprising a polyamide and at least 10% glass fibers consisting predominantly of silica dioxide (SiO2), aluminum oxide (Al2O3) and magnesium oxide (MgO) and devoid of particulate fillers made it possible to improve the mechanical properties, in particular the impact strength, and especially under cold conditions (−40° C.), compared to those of the same composition with type E glass fibers or those of the same composition without impact modifier, whether it comprises type E glass fibers or glass fibers consisting predominantly of silica dioxide (SiO2), aluminum oxide (Al2O3) and magnesium oxide (MgO).

In one embodiment, the present invention relates to one of the compositions defined above wherein said compositions exclude particulate fillers and a polyolefin-based colored masterbatch.

In another embodiment, the present invention relates to a composition, particularly useful for injection molding, consisting of:

(A) from 29 to 89%, in particular 29 to 74%, and more particularly 34 to 64%, especially from 44 to 54% by weight of at least one semi-crystalline aliphatic polyamide, said semi-crystalline aliphatic polyamide resulting from the polycondensation:
of at least one C₆ to C₁₈, preferentially C₉ to C₁₈, more preferentially C₁₀ to C₁₈, even more preferentially C₁₀ to C₁₂, especially C₁₁, amino acid, or
of at least one C₆ to C₁₈, preferentially C₉ to C₁₈, more preferentially C₁₀ to C₁₈, even more preferentially C₁₀ to C₁₂, especially C₁₂, lactam, or
of at least one C₄-C₃₆, especially C₆-C₃₆, preferentially C₆-C₁₈, preferentially C₆-C₁₂, more preferentially C₁₀-C₁₂, diamine Ca with at least one C₄-C₃₆, especially C₆-C₃₆, preferentially C₆-C₁₈, preferentially C₁₀-C₁₈, more preferentially C₁₀-C₁₂, diacid Cb;
(B) from 10 to 70, in particular 25 to 70%, and more particularly 35 to 65%, especially 45 to 55% by weight of glass fibers predominantly consisting of silica dioxide (SiO2), aluminum oxide (Al2O3) and magnesium oxide (MgO);
(C) from 1 to 20% by weight of at least one impact modifier; and
(D) from 0 to 2%, preferably 1 to 2% by weight of at least one additive, the sum of the various constituents (A) to (D) being 100% by weight.

The latter composition therefore can no longer contain copper chromite, zinc sulfide, titanium dioxide, calcium carbonate, a polyolefin-based colored masterbatch or particulate fillers;

The latter composition therefore only consists of the four constituents A to D.

Particulate fillers are well known to those skilled in the art and are especially as defined in US2014/0066561.

In particular, the particulate fillers excluded from the present invention are selected from

talc, mica, silicates, quartz, wollastonite, kaolin, silicic acids, magnesium carbonate, magnesium hydroxide, chalk, milled or cut calcium carbonate, lime, feldspar, inorganic pigments such as barium sulfate, zinc oxide, zinc sulfide, titanium dioxide, ferric oxide, ferric manganese oxide, metal oxides, in particular spinels, such as ferric copper spinel, copper-chromium oxide, zinc-ferric oxide, cobalt-chromium oxide, cobalt-aluminum oxide, magnesium-aluminum oxide, copper-chromium-manganese oxide, copper-manganese-iron oxide, rutile pigments such as titanium-zinc rutile, nickel-antimony titanate, permanently magnetic or magnetizable metals or alloys, concave silicate filling material, aluminum oxide, boron nitride, boron carbide, aluminum nitride, calcium fluoride and mixtures thereof.

They therefore include copper chromite, zinc sulfite, titanium dioxide and calcium carbonate.

The polyolefin-based colored masterbatch is as defined in US2018237598.

The polyolefin-based colored masterbatch may especially comprise colorants, pigments or dyes as color to be dispersed in the desired support resin.

Suitable pigments comprise for example inorganic pigments such as metal oxides and mixed metal oxides such as zinc oxide, titanium dioxides, iron oxides or the like; sulfides such as zinc sulfides or the like; aluminates; sodium sulfosilicates; sulfates and chromates; zinc ferrites; ultramarine blue; Pigment Brown 24; Pigment Red 101; Pigment Yellow 119; organic pigments such as azos, diazos, quinacridones, perylenes, naphthalene tetracarboxylic acids, flavanthrones, isoindolinones, tetrachloroisoindolinones, anthraquinones, anthanthrones, dioxazines, phthalocyanines and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations comprising at least one of the abovementioned pigments.

Suitable colorants comprise, for example, organic colorants such as coumarin 460 (blue), coumarin 6 (green), Nile red or the like; lanthanide complexes, hydrocarbon and substituted hydrocarbon colorants; polycyclic aromatic hydrocarbons; scintillation colorants (preferably oxazoles and oxadiazoles); poly(2-8)olefins with aryl or heteroaryl substitution; carbocyanine colorants; colorants and pigments based on phthalocyanine, oxazine colorants; carbostyril colorants; porphyrin colorants; acridin-containing colorants; anthraquinone colorants; arylmethane colorants; azo colorants; diazonium-containing colorants; nitro colorants; quinone-imine colorants; tetrazolium colorants; thiazole colorants; perylene colorants; perinone colorants; bis-benzoxazolylthiophene (BBOT); and xanthene-containing colorants; fluorophores such as anti-Stokes-shift colorants which absorb in the near infrared wavelength range and emit in the visible wavelength range, or the like; luminescent colorants such as 5-amino-9-diethyliminobenzo(a)phenoxazonium perchlorate; 7-amino-4-methylcarbostyril; 7-amino-4-methylcoumarin; 3-(2-benzimidazolyl)-7-N,N-diethylaminocoumarin, 3-(2-benzothiazolyl)-7-diethylaminocoumarin; 2-(4-biphenylyl)-5-(4-t-butylphenyl)-1,3,4-oxadiazole, 2-(4-biphenyl)-6-phenylbenzoxazole-1,3; 2,5-bis-(4-biphenylyl)-1,3,4-oxadiazole, 2,5-bis-(4-biphenylyl)-oxazole; 4,4-bis-(2-butyloctyloxy)-p-quaterphenyle; p-bis(o-methylstyryl)-benzene; 5,9-diaminobenzo(a)phenoxazonium perchlorate; 4-dicyanomethylene-2-methyl-6-(p-dimethylaminostyryl)-4H-pyran; 1,1-diethyl-2,2-carbocyanin iodide; 3,3-diethyl-4,4,5,5-dibenzothiatricarbocyanin iodide; 7-diethylamino-4-methylcoumarin; 7-diethylamino-4-trifluoromethylcoumarin; 2,2-dimethyl-p-quaterphenyl; 2,2-dimethyl-p-terphenyls 7-ethylamino-6-methyl-4-trifluoromethylcoumarin, 7-ethylamino-4-trifluoromethylcoumarin, Nile red; rhodamine 700; oxazine 750; rhodamine 800; IR 125; IR 144; IR 140; IR 132; IR 26; IR 5; diphenylhexatriene; diphenylbutadiene; tetraphenylbutadiene; naphthalene; anthracene; 9,10-diphenylanthracene, pyrene; chrysene; rubrene; coronene; phenanthrene or the like, or combinations comprising at least one of the abovementioned colorants.

Suitable dyes may comprise, for example, titanium dioxide, anthraquinones, perylenes, perinones, indanthrones, quinacridones, xanthenes, oxazines, oxazolines, thioxanthenes, indigoids, thioindigoids, naphthalimides, cyanines, xanthenes, methines, lactonesophylenes, coumarins (BBOT), naphthalenetetracarboxylic acid derivatives, monoazo and diazo pigments, triarylmethanes, aminoketones, biphenyl bis(styril) derivatives and the like, and also combinations comprising at least one thereof.

The colored masterbatch comprises a polyolefin support resin. Generally, the support resin can be selected to provide good dispersion of the dye through the support resin. In various examples, the polyolefin-based colored masterbatch can comprise a polyethylene or a polypropylene support resin, although other polyolefin-based support resins can certainly be used.

The polyolefin-based masterbatch can be mixed with the polyamide-based resin and the glass fiber.

### Regarding Polyamide (A)

The nomenclature used to define the polyamides is described in ISO standard 1874-1:2011 “Plastiques—Matériaux polyamides (PA) pour moulage et extrusion—Partie 1: Designation”, especially on page 3 (Tables 1 and 2) and is well known to the person skilled in the art.

A semi-crystalline polyamide, within the meaning of the invention, denotes a polyamide that has a glass transition temperature (Tg) and a melting temperature (Tm) determined respectively according to standard ISO 11357-2 and 3:2013, and an enthalpy of crystallization during the step of cooling at a rate of 20 K/min in DSC measured according to standard ISO 11357-3, 2013, of greater than 30 J/g, preferably greater than 35 J/g.

The semi-crystalline polyamide may be substituted by at least one amorphous polyamide in a proportion from 0 to 30% by weight.

Advantageously, the composition is devoid of amorphous polyamide.

An amorphous polyamide, within the meaning of the invention, denotes a polyamide that has only a glass transition temperature (Tg) (not a melting temperature (Tm)), the Tg being determined according to standard ISO 11357-2:2013, or a polyamide that has very little crystallinity having a glass transition temperature and a melting point such that the enthalpy of crystallization during the step of cooling at a rate of 20 K/min measured according to standard ISO 11357-3:2013 is less than 30 J/g, especially less than 20 J/g, preferably less than 15 J/g.

Said at least one amorphous polyamide may be is a homopolyamide of formula XY or a copolyamide of formula A/XY, XY being a repeating unit obtained by polycondensation of at least one cycloaliphatic diamine (X) and at least one C₄-C₃₆, especially C₆-C₃₆, preferentially C₆-C₁₈, preferentially C₆-C₁₂, more preferentially C₁₀-C₁₂ aliphatic dicarboxylic acid (Y) as defined above or of at least one aromatic dicarboxylic acid (Y) and A is a repeating unit obtained by polycondensation of at least one C₆ to C₁₈, preferentially C₁₀ to C₁₈, more preferentially C₁₀ to C₁₂, amino acid, or

at least one C₆ to C₁₈, preferentially C₁₀ to C₁₈, more preferentially C₁₀ to C₁₂, lactam, or a repeating unit obtained by polycondensation of at least one aliphatic diamine (Ca) and at least one C₄-C₃₆, especially C₆-C₃₆, preferentially C₆-C₁₈, preferentially C₆-C₁₂, more preferentially C₁₀-C₁₂, aliphatic dicarboxylic acid (Cb), as defined above.

The cycloaliphatic diamine (X) may be chosen from bis(3,5-dialkyl-4-aminocyclohexyl)-methane, bis(3,5-dialkyl-4-aminocyclohexyl)ethane, bis(3,5-dialkyl-4-aminocyclohexyl)-propane, bis(3,5-dialkyl-4-aminocyclo-hexyl)-butane, bis-(3-methyl-4-aminocyclohexyl)-methane or 3,3′-dimethyl-4,4′-diamino-dicyclohexyl-methane commonly called “BMACM” or “MACM” (and denoted B below), p-bis(aminocyclohexyl)-methane commonly called “PACM” (and denoted P hereinafter), particularly Dicykan®, isopropylidenedi(cyclohexylamine) commonly called “PACP”, isophorone-diamine (denoted IPD hereinafter) and 2,6-bis(amino methyl)norbornane commonly called “BAMN,” and bis(aminomethyl)cyclohexane “BAC”, in particular 1,3-BAC, or in particular 1,4-BAC.

Advantageously, it is chosen from bis-(3-methyl-4-aminocyclohexyl)-methane or 3,3′-dimethyl-4,4′-diamino-dicyclohexyl-methane, commonly called (BMACM) or (MACM) (and denoted B hereinafter) bis(p-aminocyclohexyl)-methane commonly referred to as (PACM) (and denoted P hereinafter) and bis(aminomethyl)cyclohexane (BAC), in particular 1,3-BAC, or in particular 1,4-BAC.

When (Y) is at least one aromatic dicarboxylic acid (Y), it is advantageously selected from terephthalic acid (denoted T), isophthalic acid (denoted I) and 2,6-naphthalene dicarboxylic acid (denoted N) or mixtures thereof; in particular it is selected from terephthalic acid (denoted T), isophthalic acid (denoted I) or mixtures thereof.

When (Y) is at least one aliphatic dicarboxylic acid, it is as defined below for Cb.

When said at least one semi-crystalline aliphatic polyamide is obtained from the polycondensation of at least one lactam, said at least one lactam may be selected from a C₆ to C₁₈ lactam, preferentially C₁₀ to C₁₈, more preferentially C₁₀ to C₁₂. A C₆ to C₁₂ lactam is especially caprolactam, decanolactam, undecanolactam, and lauryllactam.

When said at least one semi-crystalline aliphatic polyamide is obtained from the polycondensation of at least one lactam, it may therefore comprise a single lactam or several lactams.

Advantageously, said at least one semi-crystalline aliphatic polyamide is obtained from the polycondensation of a single lactam and said lactam is selected from lauryllactam and undecanolactam, advantageously lauryllactam.

When said at least one semi-crystalline aliphatic polyamide is obtained from the polycondensation of at least one amino acid, said at least one amino acid may be selected from a C₆ to C₁₈ amino acid, preferentially C₁₀ to C₁₈, more preferentially C₁₀ to C₁₂.

An amino acid C₆ to C₁₂ is especially 6-aminohexanoic acid, 9-aminononanoic acid, 10-aminodecanoic acid, 10-aminoundecanoic acid, 12-aminododecanoic acid and 11-aminoundecanoic acid and derivatives thereof, especially N-heptyl-11-aminoundecanoic acid.

When said at least one semi-crystalline aliphatic polyamide is obtained from the polycondensation of at least one lactam, it may therefore comprise a single amino acid or several amino acids.

Advantageously, said semi-crystalline aliphatic polyamide is obtained from the polycondensation of a single amino acid and said amino acid is selected from 11-aminoundecanoic acid and 12-aminododecanoic acid, advantageously 11-aminoundecanoic acid.

When said at least one semi-crystalline aliphatic polyamide is obtained from the polycondensation of at least one C₄-C₃₆, especially C₆-C₃₆, preferentially C₆-C₁₈, preferentially C₆-C₁₂, more preferentially C₁₀-C₁₂, diamine Ca with at least one C₄-C₃₆, especially C₆-C₃₆, preferentially C₆-C₁₈, preferentially C₁₀-C₁₈, more preferentially C₁₀-C₁₂, diacid Cb, then said at least one diamine Ca is an aliphatic diamine and said at least one diacid Cb is an aliphatic diacid.

The diamine may be linear or branched. Advantageously, it is linear.

Said at least one C₄-C₃₆ diamine Ca can be in particular selected from butanemethylenediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and the diamines obtained from fatty acids.

Advantageously, said at least one C₆-C₃₆ diamine Ca is in particular selected from 1,6-hexamethylenediamine, 1,7-heptamethylenediamine, 1,8-octamethylenediamine, 1,9-nonamethylenediamine, 1,10-decamethylenediamine, 1,11-undecamethylenediamine 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and the diamines obtained from fatty acids.

Advantageously, said at least one diamine Ca is C₆-C₁₈ and selected from 1,6-hexamethylenediamine, 1,7-heptamethylenediamine, 1,8-octamethylenediamine, 1,9-nonamethylenediamine, 1,10-decamethylenediamine 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one C₆ to C₁₂ diamine Ca is in particular selected from 1,5-pentamethylenediamine, 1,6-hexamethylenediamine, 1,7-heptamethylediamine, 1,8-octamethylediamine, 1,9-nonamethylediamine, 1,10-decamethylediamine, 1,11-undecamethylediamine, and 1,12-dodecamethylediamine.

Advantageously, the Ca diamine used is a C₁₀ to C₁₂ diamine, particularly chosen from 1,10-decamethylenediamine, 1,11-undecamethylenediamine, and 1,12-dodecamethylenediamine.

Said at least one C₄ to C₃₆ dicarboxylic acid Cb may be selected from butanedioic acid, pentanedioic acid, adipic acid acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

Advantageously, said at least one dicarboxylic acid Cb is C₆ to C₃₆ and is selected from adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

The diacid may be linear or branched. Advantageously, it is linear.

Advantageously, said at least one Cb dicarboxylic acid is C₆ to C₁₈ and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid.

Advantageously, said at least one dicarboxylic acid Cb is C₁₀ to C₁₈ and is selected from sebacic acid, undecanedioic acid, dodecanedioic acid, brassylic acid, tetradecanedioic acid, pentadecanedioic acid, hexadecanedioic acid, octadecanedioic acid.

Advantageously, said at least one Cb dicarboxylic acid is C₁₀ to C₁₂ and is chosen from sebacic acid, undecanedioic acid and dodecanedioic acid.

When said semi-crystalline aliphatic polyamide is obtained from the polycondensation of at least one diamine Ca with at least one dicarboxylic acid Cb and may therefore comprise a single diamine or a plurality of diamines and a single dicarboxylic acid or several dicarboxylic acids.

Advantageously, said semi-crystalline aliphatic polyamide is obtained from the polycondensation of a single diamine Ca with a single dicarboxylic acid Cb.

In one embodiment, said semi-crystalline polyamide results from the polycondensation:

of at least one C₆ to C₁₈, preferentially C₉ to C₁₈, more preferentially C₁₀ to C₁₈, even more preferentially C₁₀ to C₁₂, especially C₁₁, amino acid, or

of at least one C₆ to C₁₈, preferentially C₉ to C₁₈, more preferentially C₁₀ to C₁₈, even more preferentially C₁₀ to C₁₂, especially C₁₂, lactam.

In a first variant of this embodiment, said semi-crystalline polyamide results from the polycondensation of at least one C₉ to C₁₈ amino acid or of at least one C₉ to C₁₈ lactam.

In a second variant of this embodiment, said semi-crystalline polyamide results from the polycondensation of at least one C₁₀ to C₁₈ amino acid or of at least one C₉ to C₁₈ lactam.

In a third variant of this embodiment, said semi-crystalline polyamide results from the polycondensation of at least one C₁₀ to C₁₂ amino acid or of at least one C₁₀ to C₁₂ lactam.

In a fourth variant of this embodiment, said semi-crystalline polyamide results from the polycondensation of a C₁₁ amino acid or of a C₁₂ lactam.

In another embodiment, said semi-crystalline polyamide results from the polycondensation:

of at least one C₄-C₃₆, especially C₆-C₃₆, preferentially C₆-C₁₈, preferentially C₆-C₁₂, more preferentially C₁₀-C₁₂, diamine Ca with at least one C₄-C₃₆, especially C₆-C₃₆, preferentially C₆-C₁₈, preferentially C₁₀-C₁₈, more preferentially C₁₀-C₁₂, diacid Cb;

In a first variant of this other embodiment, said semi-crystalline polyamide results from the polycondensation of at least one C₄-C₃₆ diamine Ca with at least one C₄-C₃₆ diacid Cb.

In a second variant of this other embodiment, said semi-crystalline polyamide results from the polycondensation of at least one C₄-C₃₆ diamine Ca with at least one C₆-C₃₆ diacid Cb.

In a third variant of this other embodiment, said semi-crystalline polyamide results from the polycondensation of at least one C₄-C₃₆ diamine Ca with at least one C₆-C₁₈ diacid Cb.

In a fourth variant of this other embodiment, said semi-crystalline polyamide results from the polycondensation of at least one C₄-C₃₆ diamine Ca with at least one C₁₀-C₁₈ diacid Cb.

In a fifth variant of this other embodiment, said semi-crystalline polyamide results from the polycondensation of at least one C₄-C₃₆ diamine Ca with at least one C₁₀-C₁₂ diacid Cb.

In a sixth variant of this other embodiment, said semi-crystalline polyamide results from the polycondensation of at least one C₆-C₃₆ diamine Ca with at least one C₄-C₃₆ diacid Cb.

In a seventh variant of this other embodiment, said semi-crystalline polyamide results from the polycondensation of at least one C₆-C₃₆ diamine Ca with at least one C₆-C₃₆ diacid Cb.

In an eighth variant of this other embodiment, said semi-crystalline polyamide results from the polycondensation of at least one C₆-C₃₆ diamine Ca with at least one C₆-C₁₈ diacid Cb.

In a ninth variant of this other embodiment, said semi-crystalline polyamide results from the polycondensation of at least one C₆-C₃₆ diamine Ca with at least one C₁₀-C₁₈ diacid Cb.

In a tenth variant of this other embodiment, said semi-crystalline polyamide results from the polycondensation of at least one C₆-C₃₆ diamine Ca with at least one C₁₀-C₁₂ diacid Cb.

In an eleventh variant of this other embodiment, said semi-crystalline polyamide results from the polycondensation of at least one C₆-C₁₈ diamine Ca with at least one C₄-C₃₆ diacid Cb.

In a twelfth variant of this other embodiment, said semi-crystalline polyamide results from the polycondensation of at least one C₆-C₁₈ diamine Ca with at least one C₆-C₃₆ diacid Cb.

In a thirteenth variant of this other embodiment, said semi-crystalline polyamide results from the polycondensation of at least one C₆-C₁₈ diamine Ca with at least one C₆-C₁₈ diacid Cb.

In a fourteenth variant of this other embodiment, said semi-crystalline polyamide results from the polycondensation of at least one C₆-C₁₈ diamine Ca with at least one C₁₀-C₁₈ diacid Cb.

In a fifteenth variant of this other embodiment, said semi-crystalline polyamide results from the polycondensation of at least one C₆-C₁₈ diamine Ca with at least one C₁₀-C₁₂ diacid Cb.

In a sixteenth variant of this other embodiment, said semi-crystalline polyamide results from the polycondensation of at least one C₆-C₁₂ diamine Ca with at least one C₄-C₃₆ diacid Cb.

In a seventeenth variant of this other embodiment, said semi-crystalline polyamide results from the polycondensation of at least one C₆-C₁₂ diamine Ca with at least one C₆-C₃₆ diacid Cb.

In an eighteenth variant of this other embodiment, said semi-crystalline polyamide results from the polycondensation of at least one C₆-C₁₂ diamine Ca with at least one C₆-C₁₈ diacid Cb.

In a nineteenth variant of this other embodiment, said semi-crystalline polyamide results from the polycondensation of at least one C₆-C₁₂ diamine Ca with at least one C₁₀-C₁₈ diacid Cb.

In a twentieth variant of this other embodiment, said semi-crystalline polyamide results from the polycondensation of at least one C₆-C₁₂ diamine Ca with at least one C₁₀-C₁₂ diacid Cb.

In a twenty first variant of this other embodiment, said semi-crystalline polyamide results from the polycondensation of at least one C₁₀-C₁₂ diamine Ca with at least one C₄-C₃₆ diacid Cb.

In a twenty second variant of this other embodiment, said semi-crystalline polyamide results from the polycondensation of at least one C₁₀-C₁₂ diamine Ca with at least one C₆-C₃₆ diacid Cb.

In a twenty third variant of this other embodiment, said semi-crystalline polyamide results from the polycondensation of at least one C₁₀-C₁₂ diamine Ca with at least one C₆-C₁₈ diacid Cb.

In a twenty fourth variant of this other embodiment, said semi-crystalline polyamide results from the polycondensation of at least one C₁₀-C₁₂ diamine Ca with at least one C₁₀-C₁₈ diacid Cb.

In a twenty fifth variant of this other embodiment, said semi-crystalline polyamide results from the polycondensation of at least one C₁₀-C₁₂ diamine Ca with at least one C₁₀-C₁₂ diacid Cb.

Advantageously, said semi-crystalline aliphatic polyamide is selected from PA11, PA12 and a semi-crystalline polyamide resulting from the polycondensation of at least one C₄-C₃₆ diamine Ca with at least one C₆-C₁₈ diacid Cb.

Advantageously, said semi-crystalline aliphatic polyamide is selected from PA11, PA12 and a semi-crystalline polyamide resulting from the polycondensation of at least one C₄-C₃₆ diamine Ca with at least one C₁₀-C₁₈ diacid Cb.

Advantageously, said semi-crystalline aliphatic polyamide is selected from PA11, PA12 and a semi-crystalline polyamide resulting from the polycondensation of at least one C₄-C₃₆ diamine Ca with at least one C₁₀-C₁₂ diacid Cb.

Advantageously, said semi-crystalline aliphatic polyamide is selected from PA11, PA12 and a semi-crystalline polyamide resulting from the polycondensation of at least one C₆-C₃₆ diamine Ca with at least one C₆-C₁₈ diacid Cb.

Advantageously, said semi-crystalline aliphatic polyamide is selected from PA11, PA12 and a semi-crystalline polyamide resulting from the polycondensation of at least one C₆-C₃₆ diamine Ca with at least one C₁₀-C₁₈ diacid Cb.

Advantageously, said semi-crystalline aliphatic polyamide is selected from PA11, PA12 and a semi-crystalline polyamide resulting from the polycondensation of at least one C₆-C₃₆ diamine Ca with at least one C₁₀-C₁₂ diacid Cb.

Advantageously, said semi-crystalline aliphatic polyamide is selected from PA11, PA12 and a semi-crystalline polyamide resulting from the polycondensation of at least one C₆-C₁₈ diamine Ca with at least one C₆-C₃₆ diacid Cb.

Advantageously, said semi-crystalline aliphatic polyamide is selected from PA11, PA12 and a semi-crystalline polyamide resulting from the polycondensation of at least one C₆-C₁₈ diamine Ca with at least one C₆-C₁₈ diacid Cb.

Advantageously, said semi-crystalline aliphatic polyamide is selected from PA11, PA12 and a semi-crystalline polyamide resulting from the polycondensation of at least one C₆-C₁₈ diamine Ca with at least one C₁₀-C₁₈ diacid Cb.

Advantageously, said semi-crystalline aliphatic polyamide is selected from PA11, PA12 and a semi-crystalline polyamide resulting from the polycondensation of at least one C₆-C₁₈ diamine Ca with at least one C₁₀-C₁₂ diacid Cb.

Advantageously, said semi-crystalline aliphatic polyamide is selected from PA11, PA12 and a semi-crystalline polyamide resulting from the polycondensation of at least one C₆-C₁₂ diamine Ca with at least one C₆-C₃₆ diacid Cb.

Advantageously, said semi-crystalline aliphatic polyamide is selected from PA11, PA12 and a semi-crystalline polyamide resulting from the polycondensation of at least one C₆-C₁₂ diamine Ca with at least one C₆-C₁₈ diacid Cb.

Advantageously, said semi-crystalline aliphatic polyamide is selected from PA11, PA12 and a semi-crystalline polyamide resulting from the polycondensation of at least one C₆-C₁₂ diamine Ca with at least one C₁₀-C₁₈ diacid Cb.

Advantageously, said semi-crystalline aliphatic polyamide is selected from PA11, PA12 and a semi-crystalline polyamide resulting from the polycondensation of at least one C₆-C₁₂ diamine Ca with at least one C₁₀-C₁₂ diacid Cb.

Advantageously, said semi-crystalline aliphatic polyamide is selected from PA11, PA12 and a semi-crystalline polyamide resulting from the polycondensation of at least one C₁₀-C₁₂ diamine Ca with at least one C₄-C₃₆ diacid Cb.

Advantageously, said semi-crystalline aliphatic polyamide is selected from PA11, PA12 and a semi-crystalline polyamide resulting from the polycondensation of at least one C₁₀-C₁₂ diamine Ca with at least one C₆-C₃₆ diacid Cb.

Advantageously, said semi-crystalline aliphatic polyamide is selected from PA11, PA12 and a semi-crystalline polyamide resulting from the polycondensation of at least one C₁₀-C₁₂ diamine Ca with at least one C₆-C₁₈ diacid Cb.

Advantageously, said semi-crystalline aliphatic polyamide is selected from PA11, PA12 and a semi-crystalline polyamide resulting from the polycondensation of at least one C₁₀-C₁₂ diamine Ca with at least one C₁₀-C₁₈ diacid Cb.

Advantageously, said semi-crystalline aliphatic polyamide is selected from PA11, PA12 and a semi-crystalline polyamide resulting from the polycondensation of at least one C₁₀-C₁₂ diamine Ca with at least one C₁₀-C₁₂ diacid Cb.

Advantageously, said semi-crystalline aliphatic polyamide is selected from PA11, PA12, PA1010, PA1012, PA1210 and PA1212, in particular PA11 and PA12, especially PA11.

### Regarding Glass Fibers (B)

The glass fibers (B) consists predominantly of silica dioxide (SiO2), aluminum oxide (Al2O3) and magnesium oxide (MgO);

In one embodiment, said composition may comprise other glass fibers than the glass fibers consisting predominantly of silica dioxide (SiO2), aluminum oxide (Al2O3) and magnesium oxide (MgO), said other glass fibers being in a proportion of 0 to 49.9% by weight relative to the total weight of the glass fibers.

Advantageously, said other glass fibers are in a proportion of 0 to 40% by weight relative to the total weight of the glass fibers, especially from 0 to 30%, in particular from 0 to 20%, more particularly from 0 to 10%.

Other types of glass fiber, within the meaning of the invention, is intended to mean any glass fiber, especially as described by Frederick T. Wallenberger, James C. Watson and Hong Li, PPG industries Inc. (ASM Handbook, Vol 21: composites (#06781G), 2001 ASM International) and difference from those consisting predominantly of silica dioxide (SiO2), aluminum oxide (Al2O3) and magnesium oxide (MgO), especially of a type selected from E, R, ECR, D or T, in particular E, especially composed of 52 to 62% silicon dioxide, 12 to 16% aluminum dioxide, 16 to 25% calcium oxide, 0 to 10% borax, 0 to 5% magnesium oxide, 0 to 2% alkali metal oxides, 0-1.5% titanium dioxide and 0-0.3% ferric oxide in accordance with standard ASTM D578-00.

The glass fibers are:
either with a circular cross-section with a diameter of between 4 μm and 25 μm, preferably between 4 and 15 μm.
or with a non-circular cross-section having a L/D ratio (where L represents the largest dimension of the cross-section of the fiber and D the smallest dimension of the cross-section of said fiber) between 2 and 8, particularly between 2 and 4. L and D can be measured by scanning electron microscopy (SEM).

Advantageously, the glass fibers have a circular cross-section having a diameter of between 4 μm and 25 μm, preferably from 4 to 15 μm.

In another embodiment, said composition comprises glass fibers consisting predominantly of silica dioxide (SiO2), aluminum oxide (Al2O3) and magnesium oxide (MgO), excluding other glass fibers.

In one embodiment, the present invention relates to a composition as defined above, wherein the glass fibers (B) are high-mechanical-strength glass fibers based on silica dioxide (SiO2), aluminum oxide (Al2O3) and magnesium oxide (MgO) or high-modulus glass fibers based on silica dioxide (SiO2), aluminum oxide (Al2O3), magnesium oxide (MgO) and calcium oxide (CaO).

The expression “based on” means that the proportion of silica dioxide (SiO2), aluminum oxide (Al2O3) and magnesium oxide (MgO) is at least 78% by weight relative to the total weight of the constituents present in said fibers.

The high-mechanical-strength fibers may in particular be type S fibers, especially fibers having a modulus of elasticity >75 GPa, preferentially >78 GPa, more preferentially >80 GPa, as measured according to ASTM C1557-03.

In one embodiment, the high-strength glass fibers based on silica dioxide (SiO2), aluminum oxide (Al2O3) and magnesium oxide (MgO) or the high-modulus glass fibers based on silica dioxide (SiO2), aluminum oxide (Al2O3), magnesium oxide (MgO) and calcium oxide (CaO) consist of 58-70% by weight of silicon dioxide (SiO2), 15-30% by weight of aluminum oxide (Al2O3), 5-15% by weight of magnesium oxide (MgO), 0-10% by weight of calcium oxide (CaO) and 0-2% by weight of other oxides, such as zirconium dioxide (ZrO2), boric oxide (B2O3), titanium dioxide (TiO2) or lithium oxide (Li2O).

In another embodiment, they consist of 60 to 67% by weight of silicon dioxide (SiO2), 20 to 28% by weight of aluminum oxide (Al2O3), 7 to 12% by weight of magnesium oxide (MgO), 0 to 9% by weight of calcium oxide (CaO) and 1.5% by weight of other oxides, such as zirconium dioxide (ZrO2), boric oxide (B2O3), titanium dioxide (TiO2) or lithium oxide (Li2O).

Advantageously, they consist of: 62-66% by weight of silicon dioxide (SiO2), 22-27% by weight of aluminum oxide (Al2O3), 8-12% by weight of magnesium oxide (MgO), 0-9% by weight of calcium oxide (CaO) and 0-1% by weight of other oxides, such as zirconium dioxide (ZrO2), boric oxide (B2O3), titanium dioxide (TiO2) or lithium oxide (Li2O).

In particular, said high-strength glass fibers preferably have a tensile strength of greater than or equal to 3500 MPa, and/or an elongation at break of at least 5%, as determined according to ASTM D2343.

The high-mechanical-strength glass fibers according to the invention may be:
either with a circular cross-section having a diameter of between 4 μm and 25 μm, preferably from 4 to 15 μm
or with a non-circular cross-section having a L/D ratio (where L represents the largest dimension of the cross-section of the fiber and D the smallest dimension of the cross-section of said fiber) between 2 and 8, particularly between 2 and 4. L and D can be measured by scanning electron microscopy (SEM).

### Regarding the Impact Modifier (C)

“Impact modifier” should be understood to be a polyolefin-based polymer having a flexural modulus less than 100 MPa measured according to standard ISO 178:2010 (23° C. RH50%) and Tg below 0° C. (measured according to standard 11357-2:2013 at the inflection point of the DSC thermogram), in particular a polyolefin.

The impact modifier may also be a PEBA block polymer (polyether-block-amide) having a flexural modulus <200 MPa.

The composition may further comprise one or more impact modifiers as defined above.

The presence of an impact modifier makes it possible to confer greater ductility on the articles manufactured.

The impact modifier may be a functionalized or non-functionalized polyolefin or be a mixture of at least one functionalized polyolefin and/or at least one non-functionalized polyolefin. When the polyolefin is functionalized, part or all of the polyolefin bears a function selected from carboxylic acid, carboxylic anhydride and epoxide functions.

A polyolefin is conventionally a homopolymer or copolymer of alpha-olefins or diolefins, for example ethylene, propylene, 1-butene, 1-octene, butadiene. By way of example, mention may be made of:
the homopolymers and copolymers of polyethylene, particularly LDPE, HDPE, LLDPE (linear low-density polyethylene), VLDPE (very low-density polyethylene) and metallocene polyethylene.
homopolymers or copolymers of propylene.
ethylene/alpha-olefin copolymers such as ethylene/propylene, ethylene/octene, EPR (abbreviation for ethylene-propylene-rubber) and ethylene/propylene/diene (EPDM).
styrene/ethylene-butene/styrene (SEBS), styrene/butadiene/styrene (SBS), styrene/isoprene/styrene (SIS), styrene/ethylene-propylene/styrene (SEPS) block copolymers.
copolymers of ethylene with at least one product selected from the salts or esters of unsaturated carboxylic acids such as alkyl (meth)acrylate (for example methyl acrylate), or the vinyl esters of saturated carboxylic acids such as vinyl acetate (EVA), where the proportion of comonomer can reach 40% by weight.

Peba (polyether block amides) are copolymers containing blocks with polyamide units and blocks with polyether units. They may also contain ester functions, in particular resulting from the condensation reaction of terminal carboxylic functions of the polyamide blocks with the hydroxyl functions of the polyether blocks. Peba is commercially available, in particular under the brand name Pebax® by the company Arkema.

Advantageously, the impact modifier is selected from Fusabond® F493, Tafmer MH5020, a Lotader®, for example Lotader® 4700, Exxelor® VA1803, VA1801 and VA 1840, Orevac® IM800 or a mixture thereof; in this case, they are in a ratio ranging from 0.1/99.9 to 99.9/0.1, Kratons® FG 1901, FG 1924, MD 1653, Tuftec® M1913, M1911 and M 1943, and a Pebax®, in particular Pebax® 40R53 SP01.

The impact modifier can also be a core-shell modifier, also denoted a core-shell polymer. The “core-shell modifier” is presented in the form of fine particles having an elastomer core and at least one thermoplastic shell; the particle size is generally less than a μm and advantageously inclusively between 150 and 500 nm. The core-shell modifier has an acrylic or butadiene base.

In one embodiment, the “core-shell” impact modifier excludes a core comprising 60 to 100% by weight of butadiene units and 0 to 40% by weight of styrene units and in which the core represents 60 to 95% by weight of the “core-shell” impact modifier, and a shell comprising 80 to 100% by weight of methyl methacrylate units and 0 to 20% by weight of modification monomer units, and in which the shell represents 5 to 40% by weight of the “core-shell” impact modifier.

In another embodiment, the impact modifier of the composition excludes “core-shell” impact modifiers.

Several different impact modifiers may be present in the composition.

The content of impact modifier (C) relative to the total weight of the composition is 1 to 20% by weight.

According to certain embodiments, the content of impact modifier (C) relative to the total weight of the composition is from 1 to 15% by weight, in particular from 1 to 10% by weight.

According to another embodiment, the composition comprises from 1 to 8%, especially from 2 to 6% and in particular from 3 to 6% by weight of impact modifier relative to the total weight of the composition.

In one embodiment, the polyolefin is selected from a functionalized polyolefin or a mixture of functionalized and non-functionalized polyolefins.

Advantageously, the functionalized polyolefin is a polyolefin bearing a function selected from carboxylic acid, maleic anhydride and epoxy functions.

### Regarding the Additives (D)

The additives are selected from fluidifying agents, dyes, catalysts, stabilizers, especially thermal stabilizers, UV stabilizers, light stabilizers, surfactants, whitening agents, organic pigments, antioxidants, chain extenders, lubricants, nucleating agents, except for a particulate filler such as talc, waxes, carbon black and mixtures thereof.

Of course, the particulate fillers and glass fibers are excluded from the additives.

The additives may be present up to 2% by weight based on the total weight of the composition, in particular they are present from 1 to 2% by weight relative to the total weight of the composition.

The term “fluidifying agent” should be understood especially as prepolymers.

The prepolymer may be chosen from linear or branched aliphatic, cycloaliphatic, semi-aromatic or even aromatic polyamide oligomers. The prepolymer may also be a copolyamide oligomer or a mixture of polyamide and copolyamide oligomers. Preferably, the prepolymer has a number average molecular weight Mn from 1000 to 10000 g/mol, in particular from 1000 to 5000 g/mol. In particular, it can be monofunctional NH₂ if the chain limiter used is a monoamine for example. The number average molecular weight (Mn) or amine number is calculated according to the following formula: Mn=1000/[NH₂], [NH₂] being the concentration of amine functions in the copolyamide as determined, for example, by potentiometry.

The term “catalyst” denotes a polycondensation catalyst such as a mineral or organic acid.

Advantageously, the proportion by weight of catalyst is comprised from around 50 ppm to about 5000 ppm, particularly from about 100 to about 3000 ppm relative to the total weight of the composition.

Advantageously, the catalyst is chosen from phosphoric acid (H3PO4), phosphorous acid (H3PO3), hypophosphorous acid (H3PO2), or a mixture thereof.

The expression copper complex denotes in particular a complex between a monovalent or divalent copper salt with an organic or inorganic acid and an organic ligand.

Advantageously, the copper salt is chosen from cupric (Cu(II)) salts of hydrogen halides, cuprous (Cu(I)) salts of hydrogen halides and salts of aliphatic carboxylic acids.

In particular, the copper salts are chosen from CuCl, CuBr, CuI, CuCN, CuCl2, Cu(OAc)2, cuprous stearate.

Copper complexes are in particular described in U.S. Pat. No. 3,505,285.

Said copper-based complex may further comprise a ligand selected from phosphines, in particular triphenylphosphines, mercaptobenzimidazole, EDTA, acetylacetonate, glycine, ethylenediamine, oxalate, diethylenediamine, triethylenetetramine, pyridine, tetrabromobisphenyl-A, derivatives of tetrabisphenyl-A, such as epoxy derivatives, and derivatives of chlorodimethanedibenzo(a,e)cyclooctene and mixtures thereof, diphosphone and dipyridyl or mixtures thereof, in particular triphenylphosphine and/or mercaptobenzimidazole.

Phosphines denote alkylphosphines, such as tributylphosphine or arylphosphines such as triphenylphosphine (TPP).

Advantageously, said ligand is triphenylphosphine.

Examples of complexes and how to prepare them are described in patent CA 02347258.

Advantageously, said copper-based complex further comprises a halogenated organic compound.

The halogenated organic compound may be any halogenated organic compound.

Advantageously, said halogenated organic compound is a bromine-based compound and/or an aromatic compound.

Advantageously, said aromatic compound is in particular chosen from decabromediphenyl, decabromodiphenyl ether, bromo or chloro styrene oligomers, polydibromostyrene, the

Advantageously, said halogenated organic compound is a bromine-based compound.

Said halogenated organic compound is added to the composition in a proportion of 50 to 30,000 ppm by weight of halogen relative to the total weight of the composition, in particular from 100 to 10,000 particularly from 500 to 1500 ppm.

Advantageously, the copper:halogen molar ratio is comprised from 1:1 to 1:3000, in particular from 1:2 to 1:100.

Particularly, said ratio is comprised from 1:1.5 to 1:15.

Advantageously, the antioxidant is based on a copper complex.

The thermal stabilizer may be an organic stabilizer or more generally a combination of organic stabilizers, such as a primary antioxidant of the phenol type (for example of the type of Ciba's irganox 245 or 1098 or 1010), or a secondary antioxidant of the phosphite type.

The UV stabilizer may be a HALS, which means Hindered Amine Light Stabilizer or an anti-UV (for example Ciba's Tinuvin 312).

The light stabilizer may be a hindered amine (e.g. Ciba's Tinuvin 770), a phenolic or phosphorus-based stabilizer.

The lubricant may be a fatty acid type lubricant such as stearic acid.

The nucleating agent excludes talc and can be silica, alumina, clay

According to another aspect, the present invention relates to a method for producing the composition as defined above, wherein the constituents of said composition are mixed by compounding, in particular in a twin-screw extruder, a co-mixer or an internal mixer.

According to yet another aspect, the present invention relates to a molded article obtainable from the composition as defined above, by injection molding.

In one embodiment, said article is a quick coupler for the field of transport, especially the automotive and truck field.

In another embodiment, said article is for the field of electrics and electronics, and in particular selected from the group consisting of parts for portable devices, especially cell phones, smart watches, computers or tablets.

In yet another embodiment, said article is for the field of sport, in particular sport shoe soles and for protective items for sport, and for industrial applications.

According to yet another aspect, the present invention relates to the use of a composition as defined above in injection molding for preparing a molded article as defined above.

### EXAMPLES

### Compounding

The compositions were prepared by mixing the polymer granules with the short fibers when melted. This mixture was made by compounding on a twin-screw co-rotating MC26 type extruder with a flat temperature profile)(T° at 230° C. The screw speed is 300 rpm and the flow rate is 25 kg/h.

The introduction of the glass fibers is achieved by side feeding.

The additives and the polyamide are added during the compounding process in the main hopper.

The following compositions were prepared (E=Example of the invention C=Comparative example):

TABLE 1

| | E1 | C1 | C2 | C3 | C4 | C5 | C6 | C7 |
|---|---|---|---|---|---|---|---|---|
| PA11 | 44 | — | — | 49 | 44 | 49 | — | — |
| PA1010 | — | — | — | — | — | — | 39 | 39 |
| PA12 (Vestamid LX 9012) | — | 91 | 91 | — | — | — | — | — |
| Fiber S2 AGY544 | 50 | 4 | — | — | — | 50 | — | 60 |
| Fiber E Lanxess E CS7974 | — | — | 4 | — | — | — | — | — |
| Fibers E 295-10 (Owen Corning) | — | — | — | 50 | 50 | — | 60 | — |
| Exxelor ®VA1840 (Exxon Mobil) | 5 | | | — | 5 | — | — | — |
| Exxelor ®VA1803 (Exxon Mobil) | — | 5 | 5 | — | — | — | — | — |
| additives | 1 | — | — | 1 | 1 | 1 | 1 | 1 |

The mechanical properties of the compositions according to the invention and the comparative compositions were tested:

The PA11 and PA1010 used were prepared according to methods well-known to those skilled in the art and have a viscosity 400 Pa·s and 100 Pa·s, respectively, as measured with a capillary rheometer of Rheograph 25 type, from the Goettfer brand (die diameter 12 mm) at 260° C., at a shear rate of 110 s-1, according to standard ISO11443:2014.

TABLE 2

| | E1 | C1 | C2 | C3 | C4 | C5 | C6 | C7 |
|---|---|---|---|---|---|---|---|---|
| Tensile modulus (GPa) | 13.8 | 1.59 | 1.48 | 12 | 11.6 | 14 | 17.4 | 19.6 |
| Strain at break (MPa) | 169 | 40.4 | 41.9 | 155 | 145 | 180 | 185 | 198 |
| Elongation at break (%) | 6.2 | 267 | 42.9 | 5.5 | 6.7 | 5 | 3.2 | 2.6 |
| Charpy impact strength | 33 | 23.6 | 26.7 | 24 | 32 | — | 12 | 12 |
| at 23° C. (kJ/m²) | | | | | | | | |
| Charpy impact strength | 23 | — | — | 16 | 17 | 16 | 10 | 11 |
| at −40° C. (kJ/m²) | | | | | | | | |

The tensile modulus is measured according to ISO 527 at 23° C.

The elongation at break and the breaking strength were measured at 23° C. according to standard ISO 527.

The machine used is of the INSTRON 5966 type. The speed of the crosshead is 1 mm/min for the modulus measurement and 5 mm/min for the strain at break and elongation at break. The test conditions are 23° C., in the dry state. The samples, of ISO 527 1A geometry, were conditioned beforehand for 2 weeks at 23° C., 50% RH. The deformation is measured by a contact extensometer.

The impact strength was determined according to ISO 179/1eA (Charpy) on notched test specimens of dimension 80 mm×10 mm×4 mm, at temperature of 23° C.+/−2° C. under relative humidity of 50%+/−10% or at −40° C.+/−2° C. under relative humidity of 50%+/−10%.

These results show that the combination of impact modifier with an amount of at least 10% of glass fibers consisting predominantly of silica dioxide (SiO2), aluminum dioxide (Al2O3) and magnesium oxide (MgO) with a semi-crystalline polyamide is essential for obtaining articles resulting from the compositions of the invention having a tensile modulus and a cold resilience (Charpy impact strength) which are high compared to articles obtained from comparative compositions comprising a combination of impact modifier with an amount of at least 10% type E glass fiber with a semi-crystalline polyamide, or to articles obtained from comparative compositions comprising a combination of impact modifier with an amount of less than 10% of type E or S2 glass fibers with a semi-crystalline polyamide, or else from comparative compositions comprising a combination of an amount of at least 10% of type E or S2 glass fibers with a semi-crystalline polyamide.

1. A composition, particularly useful for injection molding, comprising:
(A) from 29 to 74% by weight of at least one semi-crystalline aliphatic polyamide, said semi-crystalline aliphatic polyamide resulting from the polycondensation:
of at least one C₆ to C₁₈, amino acid; or
of at least one C₆ to C₁₈ lactam; or
of at least one C₄-C₃₆ diamine Ca with at least one C₄-C₃₆ diacid Cb;
(B) from 25 to 70% by weight of glass fibers consisting essentially of silica dioxide (SiO2), aluminum oxide (Al2O3) and magnesium oxide (MgO);
said glass fibers (B) consisting of the following composition:
from 62 to 66% by weight of SiO2;
from 22 to 27% by weight of Al2O3;
from 8 to 12% by weight of MgO;
from 0 to 9% by weight of calcium oxide (CaO); and
from 0 to 1% by weight of other oxides,
the total being equal to 100% by weight;
(C) from 1 to 20% by weight of at least one impact modifier; and
(D) from 0 to 2% by weight of at least one additive,
excluding copper chromite, zinc sulfide, titanium dioxide, calcium carbonate and a polyolefin-based colored masterbatch;
the sum of the various constituents (A) to (D) being 100% by weight.

2. The composition according to claim 1, wherein the polyamide is selected from PA11, PA12, PA1010, PA1012, PA1210 and PA1212.

3. The composition according to claim 1, wherein the impact modifier is selected from a polyolefin-based polymer having a flexural modulus less than 100 MPa measured according to standard ISO 178:2010 (23° C. RH50) and having a Tg below 0° C. (measured according to standard 11357-2:2013 at the inflection point of the DSC thermogram).

4. The composition according to claim 3, wherein the impact modifier is a polyolefin, said polyolefin being functionalized or non-functionalized, or a mixture of both.

5. The composition according to claim 4, wherein the polyolefin is selected from a functionalized polyolefin or a mixture of functionalized and non-functionalized polyolefins.

6. The composition according to claim 4, wherein the functionalized polyolefin is a polyolefin bearing a function selected from carboxylic acid, maleic anhydride and epoxy functions.

7. The composition according to claim 1, wherein the additives are selected from fluidifying agents, dyes, catalysts, stabilizers, especially thermal stabilizers, UV stabilizers, light stabilizers, surfactants, whitening agents, antioxidants, chain extenders, lubricants, nucleating agents, waxes, and mixtures thereof.

8. The composition according to claim 1, wherein the impact modifier (C) is present at from 1 to 15% by weight.

9. A method for producing the composition as defined in claim 1, wherein the constituents of said composition are mixed by compounding.

10. A molded article obtainable from the composition according to claim 1 by injection molding.

11. The molded article according to claim 10, said article being a quick coupler for the field of transport.

12. The molded article according to claim 10, for the field of electrics and electronics, selected from the group consisting of parts for portable devices.

13. The molded article according to claim 10, for sport shoe soles and for protective items for sport.
